(19) United States
(12) Patent Application Publication
(10) Pub. No.: US 2023/0330829 A1
(43) Pub. Date: Oct. 19, 2023

(54) HEAD AND HANDLE ATTACHMENT FOR AN IMPLEMENT AND METHOD OF FABRICATION OF IMPLEMENT

(71) Applicant: GARANT GP, Saint-François-de-la-Rivière-du-Sud (CA)

(72) Inventors: Mathieu BERROUARD, Lévis (CA); Carl BLOUIN, Lévis (CA); Patrick JULIEN, Lévis (CA)

(21) Appl. No.: 18/299,095

(22) Filed: Apr. 12, 2023

Related U.S. Application Data
(60) Provisional application No. 63/362,919, filed on Apr. 13, 2022.

(51) Int. Cl. B25G 3/34; B26B 23/00

(52) U.S. Cl. CPC B25G 3/34; B26B 23/00

(57) ABSTRACT

A handle connecting part comprising a recessed surface below a top surface; a head connecting part comprising an opening, a lock comprising arms extending from a cap, each arm terminating in an inward finger, with a length La of the arms from a bottom surface of the cap to a top edge of the fingers respectively and the length Lu of the top surface of the handle connecting part, above the recessed surface, are selected in such a way that when the bottom surface of the cap abuts on the top of the head connection part, the fingers of the lock reach the second recessed surface below the first surface; the handle connecting part being locked within the opening of the head connecting part by resin.

### CROSS REFERENCE TO RELATED APPLICATIONS

This application claims benefit of U.S. provisional application Ser. No. 63/362,919, filed on Apr. 13, 2022. All documents above are incorporated herein in their entirety by reference.

### FIELD OF THE INVENTION

The present invention relates to implements comprising a tool head connected to a handle. More specifically, the present invention is concerned with a head and handle connection and a method of fabrication thereof.

### BACKGROUND OF THE INVENTION

Axes for example typically comprise with a handle and an overmolded machined head. The head must be machined following forging to achieve dimensional tolerances allowing overmolding. Such connection between the handle and the head is robust and efficient, at the expense of high manufacturing costs.

A range of implements comprise a tool head connected to a handle for a user to handle the implements.

There is still a need in the art for a head and handle connection for an implement and a method of fabrication thereof.

### SUMMARY OF THE INVENTION

More specifically, in accordance with the present invention, there is provided an implement comprising a handle and a tool head, wherein the handle comprises a handle connecting part, the handle connecting part comprising, from a first edge thereof to a second edge thereof, a first surface of a length Lu, a second surface recessed in relation to the first surface, lateral undercuts and longitudinal ribs; the head comprises a head connecting part, the head connecting part comprising an opening, extending from a top surface to a bottom surface; wherein the implement further comprises a lock, the lock comprises a cap and arms extending from the cap, each arm terminating in an inward finger; wherein a length La of the arms from a bottom surface of the cap to a top edge of the fingers respectively and the length Lu of the first surface of the handle connecting part are selected in such a way that when the bottom surface of the cap abuts on the first surface of the head connection part, the top edge of the fingers of the lock reach the second recessed surface below the first surface; wherein the handle connecting part is locked within the opening of the head connecting part by a resin.

There is further provided a method of fabrication of an implement, comprising: providing a handle comprising a handle connecting part, the handle connecting part comprising, from a first edge thereof to a second edge thereof, a first surface of a length Lu, a second surface recessed in relation to said first surface, lateral undercuts 15 below the recessed surface, and longitudinal ribs below the lateral undercuts; providing a tool head comprising an opening extending from a top surface to a bottom surface; providing a lock comprising a cap and arms extending from said cap and terminating in inward fingers respectively, the fingers pointing each other; the arms having a length La from a bottom surface of the cap to a top edge of the fingers selected in relation to the length Lu of the first surface of the handle connecting part above the second recessed surface of the handle connecting part in such a way that when the cap abuts on the top surface, the top edge of the fingers of the lock reach the second recessed surface below the first surface of the head connection part; inserting the handle connecting part within the opening; pouring a resin within the opening; before the epoxy hardens, sliding, from the top surface, the arms of the lock within the opening until the cap abuts on the top surface, the inwardly facing fingers reaching the second recessed surface of the handle connecting part on respective side of the handle connecting part within the opening; thereby locking the tool head and the handle together.

There is further provided a method of fabrication of an implement comprising a tool connected to a handle, comprising: forming a handle connecting part comprising, from a first edge thereof to a second edge thereof, a first surface of a length Lu, a second surface recessed in relation to the first surface, lateral undercuts below the recessed surface, and longitudinal ribs below the lateral undercuts; forming a head connecting part extending from a top surface to a bottom surface and forming an opening within the had connecting part; forming a lock comprising a cap and arms extending from the cap and terminating in inward fingers respectively, the fingers pointing each other, with a length La of the arms from a bottom surface of the cap to a top edge of the fingers selected in relation to the length Lu of the first surface of the handle connecting part above the second recessed surface of the handle connecting part in such a way that when the cap abuts on the top surface of the head connection part, the top edge of the fingers of the lock reach the second recessed surface below the first surface of the head connection part; inserting the handle connecting part within the opening of the head connecting part; pouring a resin within the opening; before the epoxy hardens, sliding, from the top surface of the head connection part, the arms of the lock within the opening of the head connection part until the cap abuts on the top surface of the head connection part, the inwardly facing fingers reaching the second recessed surface of the handle connecting part on respective side of the handle connecting part within the opening of the head connection part; thereby locking the tool head and the handle together.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a longitudinal side view of an implement according to an embodiment of an aspect of the disclosure;

FIG. 2 is a front view of a handle connecting part according to an embodiment of an aspect of the disclosure;

FIG. 3 is a section view of the head and handle connection along line Y-Y of FIG. 2 according to an embodiment of an aspect of the disclosure;

FIG. 4 is a detail of a top perspective side view of the implement of FIG. 1;

FIG. 5 is a perspective side view of the handle connecting part of FIG. 2;

FIG. 6 is a back view of the head and handle connection of FIG. 3, with the handle connecting part within the head connecting part shown in transparency;

FIG. 7 is a transverse section view of FIG. 6; and

FIG. 8 is an isometric view of FIG. 6.

### DESCRIPTION OF ILLUSTRATIVE EMBODIMENTS

The present invention is illustrated by the following non-limiting examples, in the case of an axe. A range of tools comprising a tool heat connected to a handle for a user to operate the tool may be contemplated, such as sledgehammers.

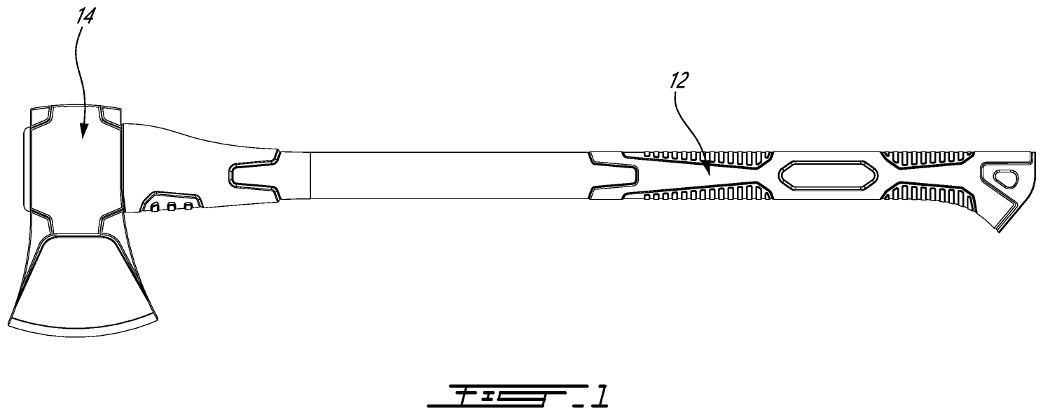

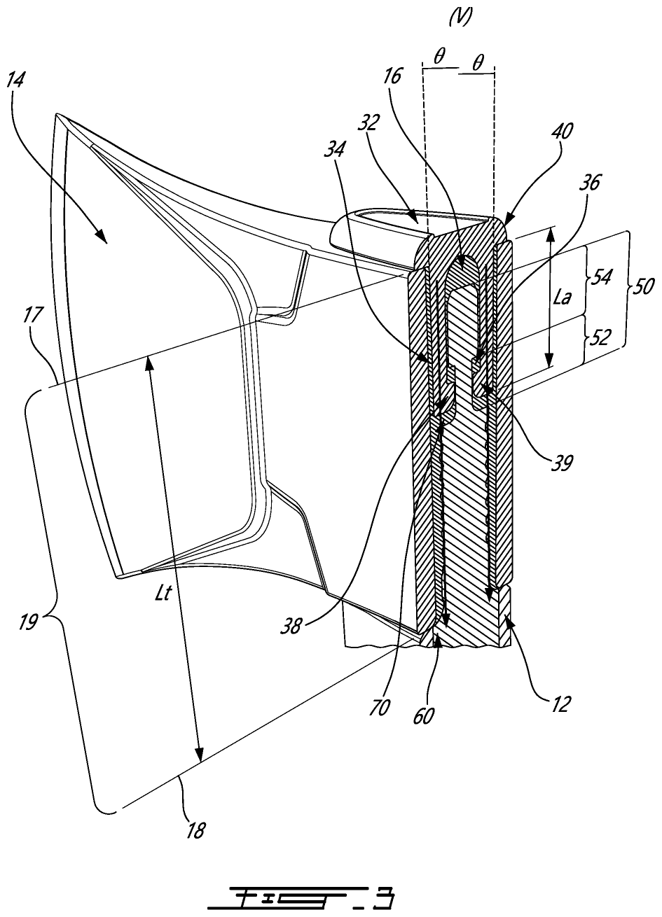

An axe according to an embodiment of the present disclosure as illustrated for example in FIG. 1 comprises a head 14 at a distal end of a handle 12. The handle 12 and the head 14 are connected together by a lock 40, shown in FIG. 3 for instance and discussed hereinbelow. In this illustrated embodiment, the handle 12 is a hollow handle molded in resin such as nylon with fiberglass for example, with flat side surfaces joining at rounded corners, in a generally rectangular cross section.

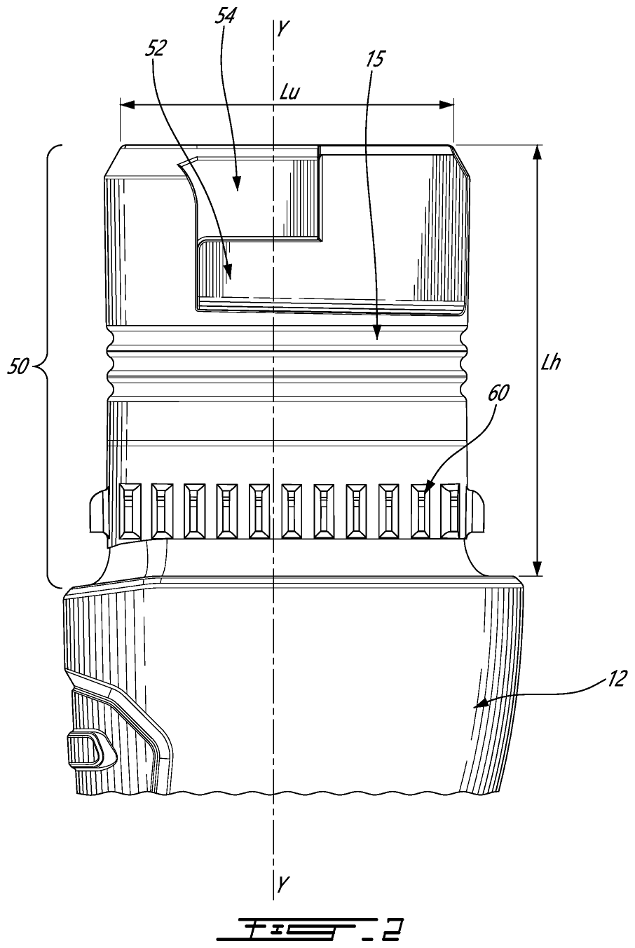

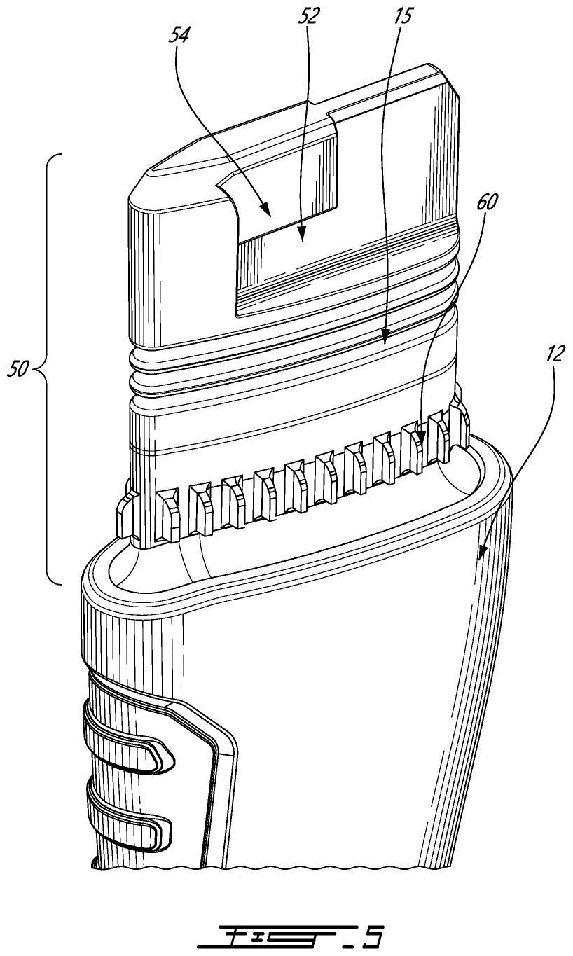

As shown in FIGS. 2 and 5, the handle 12 comprises a connecting part 50, of a length Lh from a distal edge thereof to a second edge thereof, with flat side surfaces joining at rounded corners in a generally rectangular cross section. The handle connecting part 50 comprises, from the distal edge thereof to the second edge thereof: a top surface 54 of a length Lu, a recessed surface 52 below the top surface 54, lateral undercuts 15 below the recessed surface 52 and longitudinal ribs 60, below the lateral undercuts 15, at a distance from the second edge of the handle connecting part 50.

The head 14 shown in FIG. 3 comprises a connecting part 19 of a length Lt matching the Lh of the handle connecting part. The head connecting part 19 comprises an opening 16, extending from a top surface 17 to a bottom surface 18 thereof, with a tapered profile, a tapering angle θ of about 1 degree in relation to a longitudinal axis (V) being shown in FIG. 3. In the illustrated embodiment, the tool head 14 is a wrought steel axe head.

The lock 40 is shown in FIG. 3 as a U-shaped body comprising arms 34 and 36 extending, along a length La selected in relation to, from a bottom surface of a cap 32 and terminating in inward fingers 38, 39 respectively, the fingers 38, 39 pointing each other. In the illustrated embodiment, the lock 40 is made in a material selected for rigidity, high tensile modulus and impact resistant, such as aluminum or steel for example.

The length La of the arms 34 and 36 from the cap 32 to the top edge of the fingers 38, 39 respectively and the length Lu of the top surface 54 of the handle connecting part 50 above the slot formed by the recessed surface 52 of the handle connecting part 50 are selected in such a way that when the cap 32 abuts on the top surface 17 of the head connection part 19, the fingers 38, 39 of the lock reach the recessed surface 52 and grip the bottom edge of the top surface 54, as will be described hereinbelow.

A method according to an embodiment of an aspect of the present disclosure generally comprises inserting the handle 12 by the handle connecting part 50 within the opening 16 of the head connecting part 19 from the bottom surface 18 of the head connection part 19, until the longitudinal ribs 60 of the handle connection part retain the head 14 and the handle 12 together by press-fit engagement within the opening; pouring a resin, such as epoxy for example, within the opening 16 from the top surface 17 of the head connection part 19; before the epoxy hardens, sliding, from the top surface 17 of the head connection part 19, the arms 34 and 36 of the lock 40 within the opening 16 of the head connection part 19 between the inner surface of the opening 16 of the head connection part 19 and of the outer surfaces of the handle connection part 50 until the cap 32 abuts on the top surface 17 of the head connection part 19, the inwardly facing fingers 38, 39 terminating the arms 34 and 36 of the lock 40 facing the recessed surface 52 of the handle connecting part 50 on respective side of the handle connecting part 50 within the opening 16 of the head connection part 19, the undercuts 15 of the recessed surface 52 of the handle connecting part 50 further trapping the epoxy. Once the epoxy hardens, the cap 32 and the arms are locked in position, thus prevented from sliding backward out of the head connecting part 19, and the head 14 and the handle 12 are locked together, the cap 32 of the lock 40 sealed by epoxy on the top surface 17 of the head connection part 19.

Thus, as the epoxy hardens within the opening 16, the resin locks the handle and the head locked together in place by locking their respective connecting part and the lock 40 together.

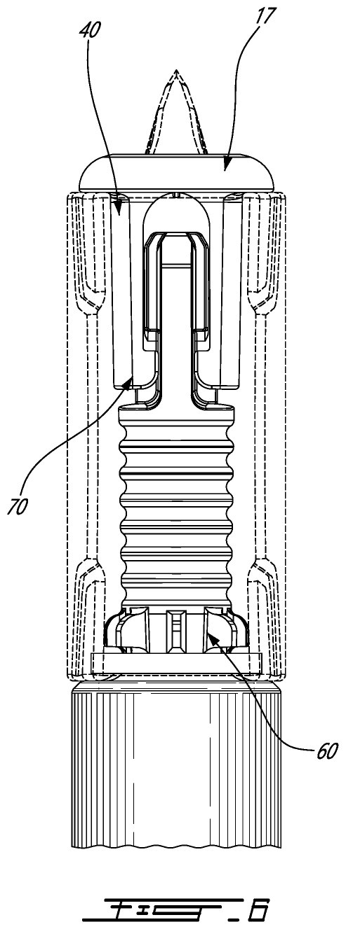

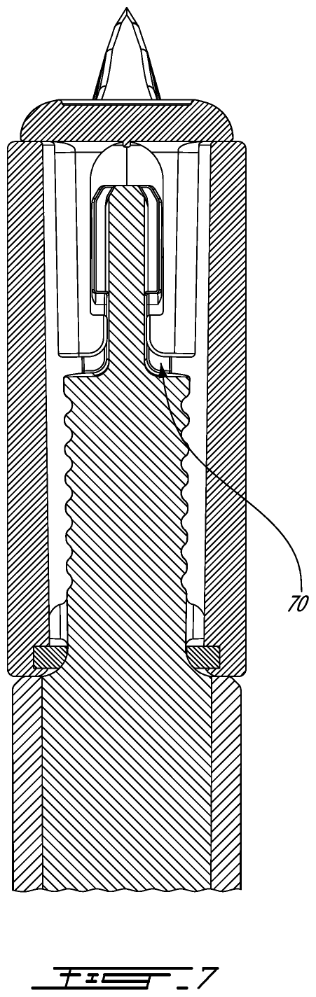

In case a wrought steel axe head, typically dimensional variations due to the forging process, are accommodated by a gap 70 (FIGS. 3, 6) may be provided between the upper edge of the recessed surface 52 of the handle connecting part 50 and the bottom edge of the fingers 38, 39 of the lock 40, as shown in FIGS. 3 and 6-8 for example

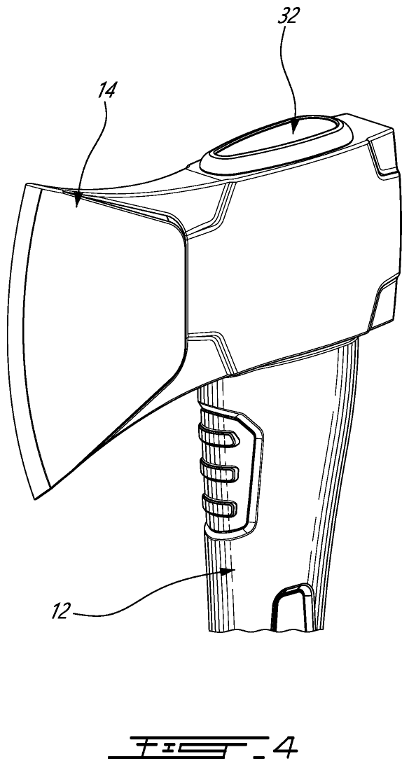

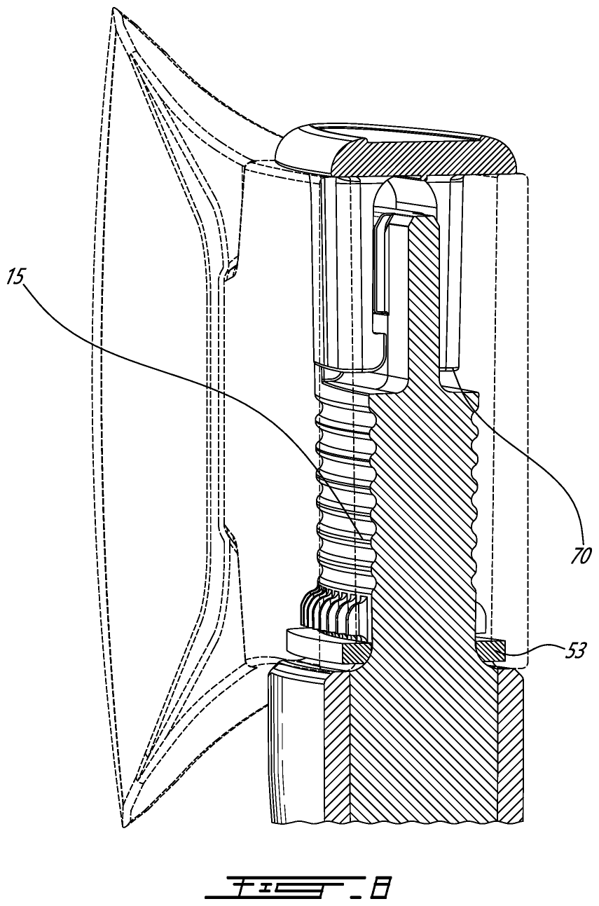

As shown in FIG. 4, a foam ring 53 (FIG. 8), such as in compressed neoprene for example, may be positioned at the bottom surface 18 of the head connecting part 19, and compressed once the distal end of the handle is inserted within the opening 16 of the head connecting part 19 and the longitudinal ribs 60 of the handle connecting part 50 engage the head connecting part and the handle 12 by press-fit, thereby sealing the opening 16 from leakage of the resin before the resin hardens. The epoxy is thus retained within the opening 16 so that the resin fills all asperities between the handle connecting part 50, the head and the lock 40 within the opening 16 of the head connecting part 19, as well as the functional gap 70 discussed hereinabove between the opening 16, the handle connecting part and the cap 32.

The cap 32, when locked in place sitting on the top surface 17 of the head connecting part seals the epoxy from view.

The cap 32 of the lock 40 may be made treated for protection the lock 40, for example against UV rays and environment that might cause breakage, and deteriorate the epoxy.

The handle, the head and the lock may be made in a range of materials, according to the implement. The handle may be a hollow handle, or a full body handle, in a polymer, a resin, wood or steel for example. The head may be in metal or an alloy for example. The lock may be in metal, alloy, polymer or resin for example.

The scope of the claims should not be limited by the embodiments set forth in the examples, but should be given the broadest interpretation consistent with the description as a whole.

1. An implement comprising a handle and a tool head, wherein:
said handle comprises a handle connecting part, the handle connecting part comprising, from a first edge thereof to a second edge thereof, a first surface of a length Lu, a second surface recessed in relation to said first surface, lateral undercuts and longitudinal ribs;
said head comprises a head connecting part, the head connecting part comprising an opening, extending from a top surface to a bottom surface;
wherein said implement further comprises lock, said lock comprises a cap and arms extending from said cap, each arm terminating in an inward finger;
wherein a length La of the arms from a bottom surface of the cap to a top edge of the fingers respectively and the length Lu of the first surface of the handle connecting part are selected in such a way that when the bottom surface of the cap abuts on the first surface of the head connection part, the top edge of the fingers of the lock reach the second recessed surface below the first surface;
wherein the handle connecting part is locked within the opening of the head connecting part by a resin.

2. The implement of claim 1, wherein the cap and the arms of the lock are locked in position, the handle are locked together, and the cap of the lock is sealed on the top surface of the head connection part, by the resin.

3. The implement of claim 1, wherein the handle connecting part is locked within the opening of the head connecting part by the fingers facing the second recessed surface of the handle connecting part on respective side of the handle connecting part within the opening of the head connection part.

4. The implement of claim 1, wherein the handle connecting part is locked within the opening of the head connecting part by the fingers facing the second recessed surface of the handle connecting part on respective side of the handle connecting part within the opening of the head connection part; the cap abutting on the top surface of the head connection part; the longitudinal ribs of the handle connection part by press-fit engagement within the opening.

5. The implement of claim 1, wherein the handle connecting part is locked within the opening of the head connecting part by the fingers facing the second recessed surface of the handle connecting part on respective side of the handle connecting part within the opening of the head connection part; the cap abutting on the top surface of the head connection part; the longitudinal ribs of the handle connection part by press-fit engagement within the opening, the undercuts of the handle connecting part further trapping the resin.

6. The implement of claim 1, wherein said opening has a tapered profile.

7. The implement of claim 1, wherein the implement is an axe, the head is a wrought steel axe head, the handle is a hollow handle molded in resin, and the lock is made in a material selected for rigidity and impact resistance.

8. The implement of claim 1, wherein the implement is an axe, the head is a wrought steel axe head, the handle is a hollow handle molded in resin, and the lock is made in one of aluminum and steel.

9. The implement of claim 1, wherein the handle is one of: a hollow handle and a full body handle, the handle comprising at least one of: a polymer, a resin, wood and steel; the head comprises at least one of: a metal and an alloy; and the lock comprises at least one of: a metal, an alloy, a polymer and a resin.

10. A method of fabrication of an implement, comprising:
providing a handle comprising a handle connecting part, the handle connecting part comprising, from a first edge thereof to a second edge thereof, a first surface of a length Lu, a second surface recessed in relation to said first surface, lateral undercuts below the recessed surface, and longitudinal ribs below the lateral undercuts;
providing a tool head comprising an opening extending from a top surface to a bottom surface;
providing a lock comprising a cap and arms extending from said cap and terminating in inward fingers respectively, the fingers pointing each other; the arms having a length La from a bottom surface of the cap to a top edge of the fingers selected in relation to the length Lu of the first surface of the handle connecting part above the second recessed surface of the handle connecting part in such a way that when the cap abuts on the top surface, the top edge of the fingers of the lock reach the second recessed surface below the first surface of the head connection part;
inserting the handle connecting part within the opening; pouring a resin within the opening; before the epoxy hardens, sliding, from the top surface, the arms of the lock within the opening until the cap abuts on the top surface, the inwardly facing fingers reaching the second recessed surface of the handle connecting part on respective side of the handle connecting part within the opening;
thereby locking the tool head and the handle together.

11. The method of claim 10, comprising inserting the handle connecting part within the opening from the bottom surface, until the longitudinal ribs of the handle connection part retain the head and the handle together by press-fit engagement within the opening.

12. The method of claim 10, the undercuts of the recessed surface of the handle connecting part trapping the resin.

13. The method of claim 10, wherein, when the tool head and the handle are locked together, the cap of the lock is sealed on the top surface.

14. The method of claim 10, wherein the opening in the tool head is selected as a tapered opening.

15. The method of claim 10, comprising selecting a wrought steel axe head, a hollow handle molded in resin, and a lock made in a material selected for rigidity and impact resistance.

16. The method of claim 10, comprising selecting a wrought steel axe head, a hollow handle molded in resin, and a lock made in one of aluminum and steel.

17. The method of claim 10, comprising selecting the handle as one of: a hollow handle and a full body handle, comprising at least one of: a polymer, a resin, wood and steel; selecting the head in at least one of: a metal and an alloy; and selecting the lock in at least one of: a metal, an alloy, a polymer and a resin.

18. A method of fabrication of an implement comprising a tool connected to a handle, comprising:
forming a handle connecting part, the handle connecting part comprising, from a first edge thereof to a second edge thereof, a first surface of a length Lu, a second surface recessed in relation to said first surface, lateral undercuts below the recessed surface, and longitudinal ribs below the lateral undercuts;
forming a head connecting part extending from a top surface to a bottom surface and forming an opening within the had connecting part;
forming a lock comprising a cap and arms extending from said cap and terminating in inward fingers respectively, the fingers pointing each other; with a length La of the arms from a bottom surface of the cap to a top edge of the fingers selected in relation to the length Lu of the first surface of the handle connecting part above the second recessed surface of the handle connecting part in such a way that when the cap abuts on the top surface of the head connection part, the top edge of the fingers of the lock reach the second recessed surface below the first surface of the head connection part;
inserting the handle connecting part within the opening of the head connecting part; pouring a resin within the opening; before the epoxy hardens, sliding, from the top surface of the head connection part, the arms of the lock within the opening of the head connection part until the cap abuts on the top surface of the head connection part, the inwardly facing fingers reaching the second recessed surface of the handle connecting part on respective side of the handle connecting part within the opening of the head connection part;
thereby locking the tool head and the handle together.

19. The method of claim 18, comprising inserting the handle connecting part within the opening of the head connecting part from the bottom surface of the head connection part, until the longitudinal ribs of the handle connection part retain the head and the handle together by press-fit engagement within the opening.

20. The method of claim 18, wherein said forming the opening comprises a tapered opening.
